(19) United States
(12) Patent Application Publication
(10) Pub. No.: US 2015/0190816 A1
(43) Pub. Date: Jul. 9, 2015

(54) REVOLVER COMPONENT FOR A REAGENT VESSEL, REAGENT VESSEL PART AND REAGENT VESSEL FOR A CENTRIFUGE AND/OR FOR A PRESSURE-VARYING DEVICE

(71) Applicant: Robert Bosch GmbH, Stuttgart (DE)

(72) Inventors: Nils Paust, Freiburg (DE); Felix von Stetten, Freiburg-Tiengen (DE); Juergen Steigert, Stuttgart (DE); Arne Kloke, Freiburg (DE); Guenter Roth, Freiburg (DE); Martina Daub, Weissach (DE)

(21) Appl. No.: 14/418,037

(22) PCT Filed: Jul. 10, 2013
(86) PCT No.: PCT/EP2013/064590

§ 371 Date: Jan. 28, 2015

(30) Foreign Application Priority Data
Aug. 2, 2012 (DE) 10 2012 213 650.9

(51) Int. Cl. B04B 7/00; B01L 3/00

(52) U.S. Cl. CPC B04B 7/00; B01L 3/52; B01L 2200/025; B01L 2400/0409

(57) ABSTRACT

A revolver component for a reagent vessel for a centrifuge and/or for a pressure-varying device includes a revolver housing which is able to be installed in the reagent vessel. Provided on the revolver housing is a guide structure, which is able to be contacted using at least one elevation provided on one reagent vessel part of the reagent vessel or provided on a further revolver component. The guide structure is developed in such a way that the revolver housing is able to be adjusted, with respect to the at least contacted reagent vessel part or with respect to the further revolver component into a first submotion along an axis and into a second submotion about the axis.

### BACKGROUND OF THE INVENTION

1. Field of the Invention

The present invention relates to a revolver component for a reagent vessel for a centrifuge and/or for a pressure-varying device. The present invention also relates to a reagent vessel part for a reagent vessel for a centrifuge and/or for a pressure-varying device. Furthermore, the invention relates to reagent vessels for a centrifuge and/or for a pressure-varying device.

2. Description of the Related Art

A device for installing in a rotor of a centrifuge is described in Published German patent application document DE 10 2010 003 223 A1. The device developed in the format of a standard centrifuge tube may include various revolvers which are situated axially one over the other. The revolvers may have channels, cavities, reaction chambers and further structures for carrying out fluidic unit operations. The revolvers may be rotated in relation to their position with respect to one another via an integrated ballpoint mechanism, whereby the structures of the revolvers with respect to one another may be switched. An actualization of the ballpoint mechanism, after installing the device in a centrifuge, may be triggered by the centrifugal force effected by the operation of the centrifuge. At the same time, liquids are able to be transferred along the force vector of the effected centrifugal force.

### BRIEF SUMMARY OF THE INVENTION

The present invention makes possible an advantageous alternative to a ballpoint pen mechanism or a ratchet mechanism. Consequently, using the present invention in outfitting a reagent vessel, one is able to do without a ballpoint pen mechanism or a ratchet mechanism or a corresponding mechanism. Instead, one may resort to the present invention, which does not require the large number of individual components precisely coordinated with one another of a ballpoint pen mechanism or a ratchet mechanism.

For example, while a ballpoint pen mechanism has at least one stator, one piston, one rotor and one spring, each of the components just cited having to be especially adapted to the additional components of the ballpoint pen mechanism, to implement the present invention, only the development of the guide structure and the at least one elevation on the revolver housing, the reagent vessel part and/or the further revolver component are required. In the case of the present invention, one may do without the development of special crosspieces having bevels at the revolvers to be positioned, complementary guide crosspieces on the housing and a resetting component.

Consequently, the present invention enables the outfitting of a reagent vessel with at least one laterally and axially adjustable revolver component at costs which are below the production costs of a ballpoint pen mechanism or a ratchet mechanism. In addition, the present invention is easy to develop on a comparatively small revolver component/reagent vessel part. While a ballpoint pen mechanism and a ratchet mechanism are able to be installed into a small reagent vessel only by using a comparatively great working effort, the present invention is easy to integrate into such a reagent vessel. Thus, the present invention is advantageously able to contribute to the minimization of lateral and rotary (azimuthally) adjustable revolver components and reagent vessels equipped with these. By contrast to a ballpoint pen mechanism, the present invention is also able to be integrated into a revolver cavity in a comparatively easy manner.

As will be stated more accurately below, the present invention even offers an improved adjustability of the revolver housing with respect to the reagent vessel part or with respect to the further revolver component. Whereas in a ballpoint pen mechanism, the lateral excursion of a revolver as well as the rotational angle of a revolver is specified identically for each actuation cycle, in the present invention different lateral excursions of the revolver housing and rotational angles of the revolver housing that deviate from one another are able to be implemented with respect to reagent vessel part or the further revolver component. In this way, chemical reactions and biochemical processes are able to be controlled/carried out in a more versatile manner.

In one advantageous specific embodiment, the guide structure developed on the revolver component is a guide groove or a guide rail. The guide structure is thus able to be set up at the same time with the revolver component. The revolver component equipped with the guide structure is therefore able to be produced as a finished unit using a production step that is simple to carry out, such as injection molding. This reduces the manufacturing costs for the revolver component.

In particular, the revolver component is able to be moved into the adjustment motion using a centrifugal force that is producible during operation of the centrifuge, in which the reagent vessel is installed, and/or a pressure force that is producible during operation of the pressure-varying device, in which the reagent vessel is installed. Thus, chemical methods and/or biochemical/molecular biological processes, which are started, carried out, optimized, controlled, prevented and/or ended, using the lateral and rotational adjustment of the revolver component, are able to be carried out during centrifuging or pressure treatment of at least one test material.

In one advantageous specific embodiment, the guide structure developed on the revolver component determines an adjustment path of the revolver component set into the adjustment motion with respect to the reagent vessel part at least contacted by the revolver housing or with respect to the further revolver component contacted by the revolver housing, along which the revolver component is adjustable from a first position to a second position with respect to the reagent vessel part at least contacted by the revolver housing, or with respect to the further revolver component contacted by the revolver housing, whereby the revolver component present in the second position, in comparison to the revolver component present in the first position is adjusted into a first adjustment direction by a first path difference unequal to zero along the axis and by a first adjustment angle unequal to zero about the axis. This ensures the lateral and rotational (azimuthal) adjustability, described above, of the revolver housing with respect to at least the reagent vessel part or the further revolver component.

In one advantageous refinement, the guide structure is developed on the revolver component in such a way that the revolver component is able to be moved along the adjustment path from the second position into a third position with respect to the reagent vessel part that is at least contacted by the revolver housing, or with respect to the further revolver component contacted by the revolver housing, the revolver component present in the third position being adjusted in comparison to the revolver component present in the second position into an opposite direction from the first adjustment direction by a second path difference unequal to zero along the axis and by a second adjustment angle unequal to zero about the axis. In particular, the second path difference may be unequal to the first path difference. As an alternative, or in supplement to it, the second adjustment angle may also deviate from the first adjustment angle. Consequently, one is able to implement a freer adjustability, compared to a ballpoint pen mechanism, of the revolver housing with respect to the reagent vessel part or the further revolver component, using this refinement.

In a further advantageous specific embodiment, the guide structure developed on the revolver component includes at least one jag-shaped and/or arched part. In particular, the guide structure developed on the revolver component may at least partially run meander-shaped and/or zigzag-shaped. As will be stated more accurately below, when using such guide structures, the adjustment path of the revolver housing, with respect to at least the reagent vessel part or the further revolver component, is able to be established with a greater number of degrees of freedom, but reliably.

In one further advantageous refinement, the revolver component is developed as one piece with at least one spring projecting outwards on the revolver housing, at least one elastic support component and/or with at least one compressible support component. Consequently, the revolver component is able to be supported, using the at least one spring, the at least one elastic supporting component and/or using the at least one compressible supporting component, on at least one housing component in such a way that the at least one elevation of the revolver component is pressed against a guide rail that is executed in a comparatively simple manner. This also simplifies installing the revolver component.

Furthermore, at least one semistable catcher structure may be developed on the guide structure developed on the revolver component. Using the at least one semistable catcher structure, the revolver component is able to be held for a longer time in a certain position with respect to at least the reagent vessel part or the further revolver component, in spite of a pressure force or a centrifugal force exerted upon it.

The advantages described above are also ensured in the case of a corresponding reaction vessel part for a reaction vessel for a centrifuge and/or for a pressure-varying device for cooperation with the revolver component. The reaction vessel part may particularly also be the reaction vessel or an outer housing of the reaction vessel.

The advantages described are also able to be implemented using a reagent vessel equipped with at least one corresponding revolver component and/or at least one such reaction vessel part.

### BRIEF DESCRIPTION OF THE DRAWINGS

FIGS. 1a-1d show schematic representations of first specific embodiment of the revolver component and the reagent vessel.

FIG. 2 shows a schematic representation of second specific embodiments of the revolver component and the reagent vessel.

FIGS. 3a and 3b show schematic representations of third specific embodiment of the revolver component.

FIG. 4 shows a schematic representation of fourth specific embodiment of the revolver component and the reagent vessel.

FIG. 5 shows a schematic representation of a fifth specific embodiment of the revolver component or of the reaction vessel.

FIG. 6 shows a schematic representation of a sixth specific embodiment of the revolver component or of the reaction vessel.

### DETAILED DESCRIPTION OF THE INVENTION

The figures explained below each show a reagent vessel part 10a of a reagent vessel 10 and/or a revolver component 12 for a reagent vessel 10. Each of reagent vessels 10 has an outer shape (not illustrated in detail), which is developed in such a way that reagent vessel 10 is able to be installed in a centrifuge and/or in a pressure-varying device. Preferably, reagent vessel 10 is developed so that a reliable support/seat of reagent vessel 10 in the operated centrifuge and/or in the operated pressure-varying device is ensured. By a reagent vessel 10 for a centrifuge and/or a pressure-varying device one may thus understand a reagent vessel 10 which, based on its outer shape, is well suited for operating the centrifuge having a comparatively high rotational speed and/or for, applying an overpressure and/or underpressure that deviates sharply from the atmospheric pressure, using the pressure-varying device.

By reagent vessel 10 one may understand a (standard) test glass/test tube. Other exemplary embodiments are centrifuge tubes, 1.5 ml Eppendorf tubes, 2 ml Eppendorf tubes 5 ml Eppendorf tubes and microtitration plates, such as 20 μl microtitration plates (per cavity). Reagent vessel 10 may particularly be/include a revolver drum/drum. It should be pointed out, however, that the feasibility of reagent vessel 10 is not limited to the examples listed here. In addition, the measurements of reagent vessel 10 are specified only based on the desired installation feasibility of reagent vessel 10 in the centrifuge and/or in the pressure-varying device. The practicality of the subsequently described technologies according to the present invention does not, however specify any outer shape of reagent vessel 10. Therefore, reagent vessel 10 may be designed to accommodate samples of any quantity, which may be selected optionally from a range of a few μl up to 1 l.

Let it be pointed out that no particular unit types are to be understood by the centrifuge and the pressure-varying device mentioned subsequently. Instead, the technology according to the present invention may be used with any centrifuge that is able to exert a (minimum) centrifugal force beginning at 20 g. The technology according to the present invention is likewise able to be used for any pressure-varying device by which an underpressure and/or overpressure is able to be applied.

By revolver component 12 one may understand a revolver. Revolver component 12 has a revolver housing 12a, which is able to be installed in at least one reagent vessel 10. The respective reagent vessel 10 may be developed as one of the specific embodiments enumerated above, without being limited to these. The ability to install revolver housing 12a in respective reagent vessel 10 for a centrifuge and/or a pressure-varying device may be interpreted in such a way that an outer wall 12b of revolver housing 12a at least partially corresponds to an inner wall 10c of reagent vessel 10 or rather, of a reagent vessel part 10a. Preferably, a reliable support/seat of revolver component 12 in respective reagent vessel 10, or reagent vessel part 10a is ensured even during operation of the centrifuge and/or the pressure-varying device.

By reagent vessel part 10a one may particularly understand reagent vessel 10, a housing component of reagent vessel 10 or an outer housing of reagent vessel 10. Provided reagent vessel part 10a is a housing component of reagent vessel 10 or an outer housing of reagent vessel 10, outer wall 10b of reagent vessel part 10a is developed corresponding to the advantageous outer shape of reagent vessel 10. However, reagent vessel part 10a may also be a component that is able to be installed in an inner volume of the outer housing of reagent vessel 10. In this case, reagent vessel part 10a is preferably shaped in such a way that revolver housing 12a of revolver component 12 is able to be installed at least partially into a depression or a cavity 10 of reagent vessel part 10a. Reagent vessel part 10a may particularly be a revolver drum/drum.

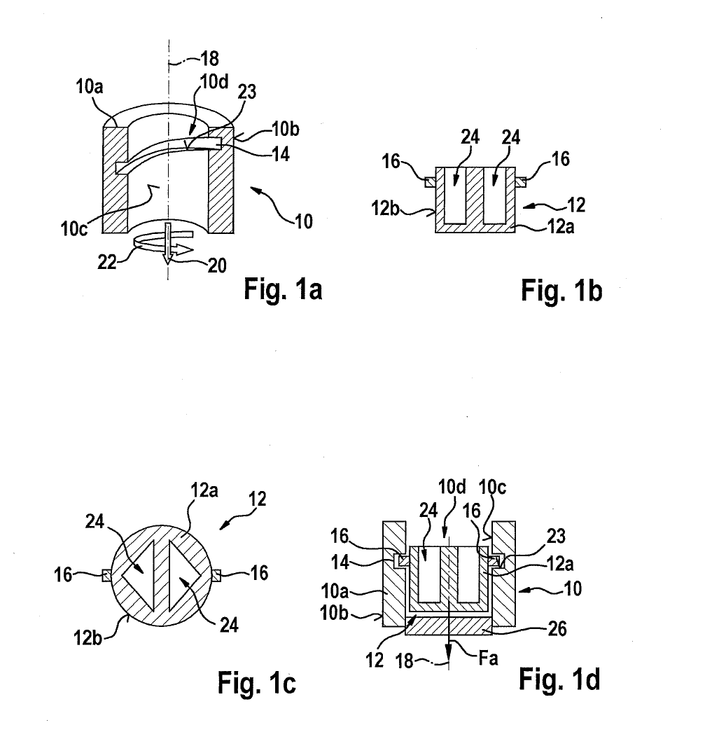

FIGS. 1a through 1d show schematic representations of first specific embodiments of the revolver component and of the reaction vessel.

Reagent vessel 10 shown as reagent vessel part 10a in FIG. 1a is suitable for cooperating with revolver component 12/revolver of FIGS. 1b and 1c. For this purpose, a guide structure 14 is developed on reagent vessel part 10a of reagent vessel 10, which is able to be contacted using at least one elevation 16 developed on revolver housing 12a of revolver component 12. Guide structure 14 developed on reagent vessel 10 is a guide groove or a guide rail, for example. In particular, guide structure 14 may be developed on inner wall 10c of reagent vessel part 10a. However, as will be explained below, the feasibility of guide structure 14 is not limited to inner wall 10c of reagent vessel part 10a. Guide structure 14 may have edges or be developed to be rounded off. A depth, height and/or width of guide structure 14 may be below 1 cm, particularly below 5 mm. The numerical values named here should only be interpreted as being exemplary, however.

Guide structure 14 is developed so that revolver housing 12a is able to be adjusted with respect to reagent vessel part 10a contacted by revolver housing 12a, while the at least one elevation 16 glides along the contacted guide structure 14. By this one may also understand that revolver housing 12a remains stationary during the gliding of the at least one elevation 16 along guide structure 14, and thus executes a relative motion with respect to reagent vessel part 10a adjusted in the chamber.

An adjustment motion (carried out during the gliding of the at least one elevation 16 along guide structure 14) of revolver housing 12a with respect to reagent vessel part 10a contacted by revolver housing 12a includes a first submotion 20 along an axis 18, axis 18 running centrically through revolver housing 12a and/or reagent vessel part 10a. In addition, the adjustment motion includes an additional second submotion 22 directed about axis 18. Consequently, second submotion 22 is a rotational motion of revolver housing 12a with respect to reagent vessel part 10a. By contrast, first submotion 20 runs parallel to axis 18. We point out once more that submotions 20 and 22 are able to be carried out either by revolver housing 12a or by reagent vessel part 10a. One may paraphrase the adjustment motion (carried out during the gliding of the at least one elevation 16 along guide structure 14) in such a way that revolver housing 12a set into first submotion 20 with respect to reagent vessel part 10a is additionally also set into second submotion 22 that is directed about axis 18. Axis 18 may particularly be the longitudinal axis/center longitudinal axis of revolver housing 12a and/or reagent vessel part 10a.

As a rule, guide structure 14 has at least one contact surface 23, at/on which the at least one elevation 16 glides along, contact surface 23, at least in stretches, being formed in such a way that a vector aligned perpendicular to it has, at the same time, a first vector component aligned perpendicular to axis 18, that is unequal to zero and a second vector component aligned parallel to axis 18, that is unequal to zero. This has the effect that a force aligned in the direction of axis 18, which is exerted upon revolver housing 12a or on reagent vessel part 10a, not only brings about first submotion 20 of revolver housing 12a with respect to reagent vessel part 10a, but also second submotion 22, triggered thereby, of revolver housing 12a with respect to reagent vessel part 10a.

Guide structure 14 developed on reagent vessel part 10a and the at least one elevation 16 of revolver housing 12a thus implement a positioning mechanism by which revolver housing 12a is adjustable both laterally (along axis 18) and azimuthally/rotationally (about axis 18) with respect to reagent vessel part 10a. The implemented positioning mechanism, together with guide structure 14 and the at least one elevation 16, requires comparatively few components. In addition, guide structure 14 and the at least one elevation 16 may be developed in a simple manner and in a relatively small size. Furthermore, the positioning mechanism formed from guide structure 14 and the at least one elevation 16 has a comparatively simple geometry. The simple design of the positioning mechanism permits its integration into a revolver component 10 and particularly into a revolver cavity. Consequently, the positioning mechanism described here for a plurality of revolver components 12, reagent vessel parts 10a and reagent vessels 10 may be utilized.

FIG. 1b shows a cross section through the revolver component. FIG. 1c shows a top view on the revolver component. The at least one elevation 16 may have a height, width and/or depth, for example, which is less than 1 cm, particularly less than 5 mm. In addition, the at least one elevation 16 may be circular, rectangular, oval and/or rounded off. The at least one elevation 16 is preferably developed so that it fits into a guide structure 14 that is developed as a guide groove. The numerical values named here should only be interpreted as being exemplary, however.

As may be seen in FIGS. 1b and 1c, at least one cavity 24/chamber is able to be developed in revolver housing 12a. The feasibility and the number of cavities 24 of revolver component 12 may be selected optionally.

FIG. 1d shows reagent vessel part 10a after the installation of revolver component 12 of FIGS. 1b and 1c and a further revolver component 26. Further revolver component 26 may be able to be situated/be situated firmly in reagent vessel part 10a. As an alternative to this, the further revolver component 26 may be able to be situated in an adjustable manner to reagent vessel 10, using an additional guide structure, which is able to be contacted using additional elevations.

Revolver housing 12 of revolver component 12 /the revolver component 12, after its installation into reagent vessel 10 and in the presence of a contact/touching contact between guide structure 14 and the at least one elevation 16, is able to be put into the adjustment motion having submotions 20 and 22, using an actuator force Fa. Actuator force Fa, may particularly be an effected centrifugal force during the operation of a centrifuge, in which the reagent vessel 10 is situated, and/or an effected pressure force during the operation of a pressure-varying device, in which the reagent vessel 10 is installed. Consequently, revolver component 12, while utilizing the positioning mechanism from guide structure 14 and the at least one elevation 16, may be adjusted in a targeted manner with respect to reagent vessel part 10a and/or further revolver component 26. Using the targeted adjustment of revolver component 12 with respect to reagent vessel part 10a and/or further revolver component 26, at least one chemical reaction and/or at least one biochemical process may be purposefully started, carried out, controlled, optimized, prevented and/or terminated. For instance, cavities 24 of the at least two revolver components 12 and 26 may be connected with respect to each other in such a way that liquids and/or powder are mixed with one another, pumped, filtered and/or separated from one another. In particular, the two revolver components 12 and 26 may be situated so close to each other that, using actuator force Fa, at least one liquid and/or at least one powder are able to be transferred from one of the two revolver components 12 and 26 into the other of the two revolver components 12 and 26 without leakage.

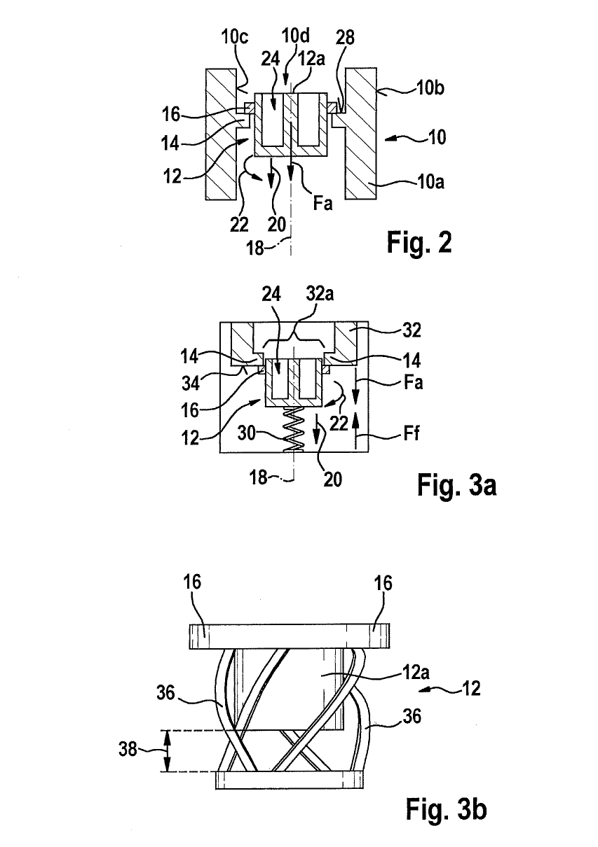

FIG. 2 shows a schematic representation of second specific embodiments of the revolver component and the reagent vessel.

In the exemplary embodiments of FIG. 2, guide structure 14 developed on reagent vessel part 10a is developed as a guide rail. The revolver component 12/the revolver is able to be installed in reagent vessel part 10a in such a way that the at least one elevation 16 of revolver component 12 contacts guide structure 14 developed as guide rail at a surface 28 which is aligned counter to actuator force Fa. Using components 14 and 16, a suspension of revolver component 12 may thus also be implemented, whereby at the same time the advantageous adjustability of the revolver component into submotions 20 and 22 remain ensured.

FIGS. 3a and 3b show schematic representations of third specific embodiments of the revolver component.

Revolver component 12 shown in FIG. 3a together with a further revolver component 32 and shown enlarged in FIG. 3b is developed in one piece with the at least one spring 30 that projects outside on revolver housing 12a. Using the at least one spring 30, revolver component 12/the revolver may support itself on a housing component (not shown) in such a way that revolver component 12 is able to be brought into a contact/touching contact with the further revolver component 32, using a spring force Ff, which is directed counter to actuator force Fa that able to be effected.

Revolver housing 12a may at least partially extend into a depression 32a and/or a cavity of further revolver component 32. As may be seen in FIG. 3a, a guide structure 14 is developed on further revolver component 32, which is able to be contacted at a surface 34, aligned in the direction to actuator force Fa, by at least one elevation 16 of revolver housing 12a. In this case, guide structure 14 is preferably developed as a guide rail. As an alternative to this, guide structure 14 may also, however, be developed as a guide groove. Similarly, in revolver housing 12a, a guide structure 14 may be developed which, using at least one elevation of the further revolver component 32, is able to be contacted. In all cases guide structure 14, as described above, may be developed so that revolver housing 12a is able to be set into an adjustment motion including submotions 20 and 22 with respect to further revolver component 32, using actuator force Fa. Consequently, using the advantageous positioning mechanism, processes running between revolver components 12 and 32 may also be advantageously controlled. This may be utilized for a large number of chemical reactions and biochemical processes.

Spring 30 may be developed as a spiral spring. Spring 30 may also be developed as a multi-strand spring (see FIG. 3b). By this one may understand that spring 30 has a plurality of spring strands 36 anchored on revolver housing 12a, which wind around at least one part of revolver housing 12a. Such a type of spring is adjustable by a comparatively big differential path 38 without tilting of revolver housing 12a. We point out, however, that revolver component 12 being developed in one piece with the at least one spring 30 is not limited to a certain type of spring.

As an alternative to the specific embodiment of FIGS. 3a and 3b, revolver component 12 may also be developed in one piece with at least one elastic support component and/or with at least one compressible support component. The at least one elastic support component and/or the compressible support component may include a polymer and/or an elastomer.

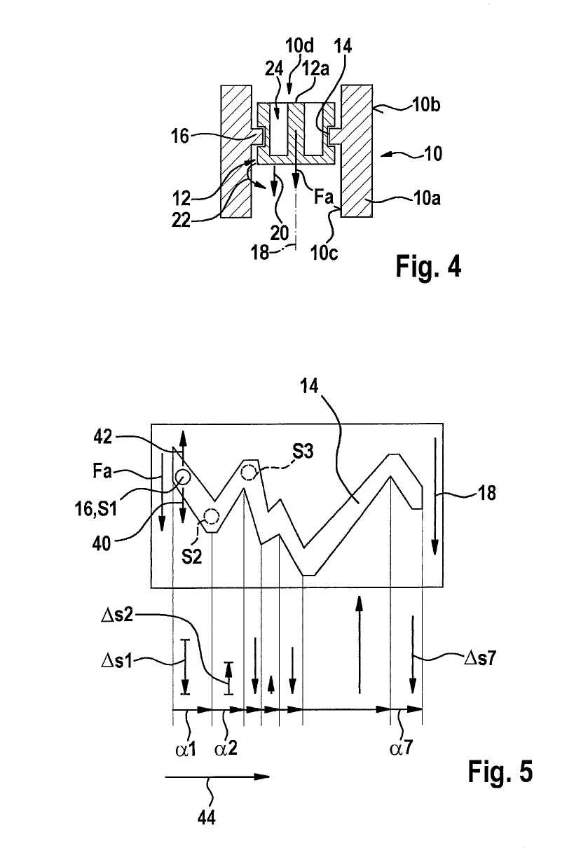

FIG. 4 shows a schematic representation of fourth specific embodiments of the revolver component and the reagent vessel.

Revolver component 12 shown schematically in FIG. 4 has a guide structure 14 which, using at least one elevation 16 is able to be contacted using at least one elevation 16 developed on reagent vessel part 10a of reagent vessel 10. Guide structure 14 is developed so that revolver housing 12a of revolver component 12 is able to be adjusted with respect to reagent vessel part 10a contacted by revolver housing 12a, the adjustment motion of revolver housing 12a with respect to reagent vessel part 10a contacted by revolver housing 12a includes first submotion 20 that is aligned along axis 18 running centrically through revolver housing 12a and reagent vessel part 10a, and includes additional second submotion 22 that is directed about axis 18. One may also restate this to say that guide structure 14 developed on revolver housing 12a is aligned so that the adjusted revolver housing 12a, adjusted into first submotion 20 with respect to contacted reagent vessel part 10a, is also able to be adjusted, along with that, into the additional second submotion 22 that is directed about axis 18.

In the exemplary embodiments of FIG. 4, guide structure 14 developed on revolver component 12 is developed as a guide groove. As an alternative to this, guide structure 14 may also be a guide rail.

The guide structure 14 developed on revolver component 12 and the at least one elevation 16 of reagent vessel part 10a developed for this, ensure the advantages already described above. With respect to additional features of the specific embodiment of FIG. 4, we therefore refer to the above and the subsequent descriptions.

FIG. 5 shows a schematic representation of a fifth specific embodiment of the revolver component or the reagent vessel.

In the specific embodiment of FIG. 5, guide structure 14 is developed as a guide groove. We point out, however, that the statements made subsequently are also correspondingly transferable to a guide structure 14 developed as a guide rail. Guide structure 14 may be developed on a revolver component 12 and 32 or on a reagent vessel part 10a. The advantages described subsequently are able to be implemented without this being dependent on components 10a, 12 or 32 being equipped with guide structure 14.

Guide structure 14 developed on revolver component 12 or 32, or reagent vessel part 10a, determines an adjustment path of revolver component 12 put into the adjustment motion with respect to reagent vessel part 10a contacted by revolver housing 12a or with respect to the further revolver component 32 contacted by revolver housing 12a. The at least one schematically reproduced elevation 16 is correspondingly guidable in guide structure 14 developed as a guide groove. Revolver component 12 guided along the adjustment path is adjustable at least from a first position S1 to a second position S2 with respect to reagent vessel part 10a contacted by revolver housing 12a or with respect to further revolver component 32 contacted by revolver housing 12a. Revolver component 12 that is present in second position S2, in comparison with revolver component 12 that is present in first position S1, is adjusted with respect to reagent vessel part 10a or further revolver component 32 in a first adjustment direction 40 about a first path difference Δs1 unequal to zero along axis 18, and by a first adjustment angle α1 unequal to zero into a rotational direction 44 about axis 18. (Actuator force Fa that is able to be effected as a pressure force or a centrifugal force may be aligned in first adjustment direction 40.)

In one advantageous specific embodiment, guide structure 14 developed on revolver component 12 or 32 or on reagent vessel part 10a includes at least one jag-shaped and/or arch-shaped part. In particular, guide structure 14 developed on revolver component 12 or 32 or on reagent vessel part 10a is able to run at least partially meander-shaped and/or zigzag-shaped. In these cases, revolver component 12 is also able to be reliably guidable into a second adjustment direction 42 that is directed counter to first adjustment direction 40 with respect to reagent vessel part 10a contacted by revolver component 12 or with respect to further revolver component 32 contacted by revolver component 12. In order to adjust revolver component 12 into second adjustment direction 42, particularly at least one spring, at least one elastic component and/or at least one compressible component may be utilized, in order to exert a force on revolver component 12 that is directed in second adjustment direction 42/directed counter to actuator force Fa. In order to adjust revolver component 12 into second adjustment direction 42, actuator force Fa may intermittently be regulated so that it is smaller than the at least one force of the at least one spring, the at least one elastic component and/or the at least one compressible component. In the meantime, if an adjustment of revolver component 12 into first adjustment direction 40 is preferred again, actuator force Fa may be set intermittently to be greater than the at least one force of the at least one spring, the at least one elastic component and/or the at least one compressible component.

Let it be pointed out that, in the advantageous development of guide structure 14 described in the preceding paragraph, both the adjustment motion carried out in the first adjustment direction 40 and the adjustment motion effected in the second adjustment direction 42 of revolver component 12 with respect to reagent vessel part 10a contacted by revolver component 12, or with respect to further revolver component 32 contacted by revolver component 12, are a guided motion. Independently of adjustment direction 40 or 42, the adjustment motion of revolver component 12 is able to be established using a corresponding development of guide structure 14 free from deviation. The drifting of revolver component 12 away from the preferred path of motion is reliably prevented. Thereby an advantageous adjustability of revolver component 12 in two oppositely directed adjustment directions 40 and 42 are able to be effected in a simple manner, using the development of guide structure 14 and a corresponding setting/varying of actuator force Fa.

Provided guide structure 14 includes at least one jag-shaped and/or arched part, guide structure 14 developed on revolver component 12 or 32 or on reagent vessel part 10a is developed so that revolver component 12 is adjustable along the adjustment path from second position S2 to a third position S3, with respect to reagent vessel part 10a contacted by revolver housing 12a, or with respect to further revolver component 32 contacted by revolver housing 12a. In the specific embodiment of FIG. 5, revolver component 12, that is present in third position S3, in comparison to revolver component 12 that is present in second position S2 is adjusted into the second adjustment direction 42 by a second path difference Δs2 that is unequal to zero along axis 18 and by a second adjustment angle α2, that is unequal to zero in the rotational direction 44 about axis 18.

For instance, the (maximum) second path difference Δs2 may be unequal to the (maximum) first path difference Δs1. As an alternative or as a supplement to this, the (maximum) adjustment angles α1 and α2 may also deviate from each other. As may be seen in FIG. 5, based on the advantageous development of guide structure 14, revolver component 12 is alternatingly adjustable, using the varying of actuator force Fa, into first adjustment direction 40 and second adjustment direction 42. In this context, different (maximum) path differences Δs2 to Δs7 and (maximum) adjustment angles α1 to α7 are able to be implemented.

The advantageous design of guide structure 14 thus has the effect, together with the varying of the actuator force Fa, of bringing about a flexible revolver positioning by different path differences Δs1 to Δs7, adjustment angles differing from one another α1 to α7, and oppositely aligned adjustment directions 40 and 42 into a single rotational direction 44 about axis 18 during a rotation of revolver component 12. Consequently, the adjustability of revolver component 12 is significantly increased over a ballpoint pen mechanism that is limited to a single (maximum) adjustment path and a fixed (maximum) adjustment angle. The angular positioning carried out along the single rotational direction 44 in a desired number of steps is able to amount to more than 360°.

It should be pointed out that the advantages stated above also apply, provided a position S1, S2 and S3 of a stationary revolver component 12 is changed with respect to reagent vessel part 10a adjusted in the chamber or with respect to further revolver component 32 adjusted in the chamber. The concept of a position S1, S2 and S3 of revolver component 12 may thus be understood as position S1, S2 and S3 of revolver component 12 with respect to reagent vessel part 10a contacted by revolver housing 12a or with respect to further revolver component 32 contacted by revolver housing 12a.

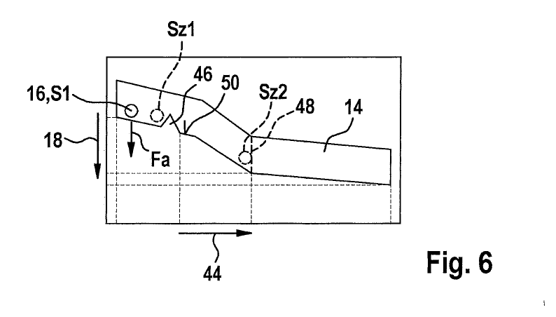

FIG. 6 shows a schematic representation of a sixth specific embodiment of the revolver component or the reagent vessel.

Guide structure 14 reproduced in FIG. 6 is developed as a guide groove only in exemplary fashion. The subsequent explanations apply correspondingly also to a guide structure 14 developed as a guide rail. Guide structure 14 may be developed on a revolver component 12 and 32 or on a reagent vessel part 10a. The advantages described subsequently are able to be implemented without this being dependent on components 10a, 12 or 32 being equipped with guide structure 14.

As is shown schematically in FIG. 6, at least one semistable catcher structure 46 and 48 is developed on guide structure 14 developed on revolver component 12 or 32 or on reagent vessel part 10a. The at least one semistable catcher structure 46 and 48 may also be designated as a (semistable) obstacle structure and/or as a (semistable) barrier.

In the specific embodiment of FIG. 6, a first catcher structure 46 is developed as a tapering of guide structure 14 developed as a guide groove. First catcher structure 46 is particularly developed as a catching jag 46, which projects at an inner surface 50 directed counter to actuator force Fa of guide structure 14 developed as a guide groove. Such a catching jag 46 may also fulfill the function subsequently described on a surface of a guide structure 14 developed as a guide rail that is directed counter to actuator force Fa. Instead of catching jag 46, a valley structure, depression and/or hook structure may also be developed on surface 50.

A second catcher structure 48 is developed as a rupture joint 48, which in an unbroken state at least partially cuts through guide structure 14 developed as a guide groove. Rupture joint 48 may be developed, for instance, as a very thin diaphragm, especially as a thin polymer diaphragm. Rupture joint 48 may also be developed as a separating wall having at least one easily broken through breaking point. Catcher structure 48 may also be a thin polymer crosspiece, which at least partially extends into guide structure 14 developed as a guide groove. A rupture joint 48, which breaks and/or rips as of a certain pressure exerted upon it, may also project at guide structure 14 developed as a guide rail.

The at least one semistable catcher structure 46 and 48 may already be developed on revolver component 12 or 32 or on reagent vessel part 10a during their manufacturing process. To form rupture joint 48, the material of revolver component 12 or 32 contacted by rupture joint 48 or of reagent vessel part 10a may be used, in particular. The method step of forming the at least one semistable catcher structure 46 and 48 may therefore be easily integrated into the production process of revolver component 12 or 32 or of reagent vessel part 10a.

Using the at least one semistable catcher structure 46 and 48, revolver component 12a is able to be intermediately supported in an intermediate position Sz1 and Sz2 with respect to reagent vessel part 10a contacted by revolver housing 12a or with respect to by revolver housing 12a. Revolver component 12 present in the at least one intermediate position Sz1 and Sz2 is held in the at least one intermediate position Sz1 and Sz2 until the actuator force Fa exerted on revolver component 12 exceeds the force required to overcome/break the contacted semistable catcher structure 46 and 48. The at least one semistable catcher structure 46 and 48 is thus used as a barrier/obstacle able to be overcome, using which a motion of revolver component 12 from the respective intermediate position Sz1 and Sz2 is prevented for a waiting period that is able to be established. As long as actuator force Fa is below a threshold value that is defined by the respective semistable catcher structure 46 and 48, revolver component 12 remains in the respective intermediate position Sz1 and Sz2. As soon as the actuator force Fa (increased in the meantime) exceeds the threshold value defined by the respective semistable catcher structure 46 and 48, the contacted semistable catcher structure 46 and 48 releases revolver component 12 again. Using an increase in the actuator force Fa to a value that is sufficient for overcoming/breaking through the contacted, semistable catcher structure 46 and 48, the relative motion of revolver component 12 with respect to reagent vessel part 10a contacted by revolver housing 12a or with respect to further revolver component 32 contacted by revolver housing 12a may be started over again.

The time at which the at least one catcher structure 46 or 48 releases revolver component 12 again may be specifically specified using a development of catcher structure 46 or 48 and establishing the rotational speed of the centrifuging process or of the pressure difference of the pressure treatment. The boundary value/threshold value for the rotational acceleration/rotational speed of the centrifuge, as of which the effected centrifugal force is sufficient to overcome catcher structure 46 or to break the at least one rupture joint 48, may be at least 20 g, for instance, at least 100 g, preferably at least 500 g, especially at least 1000 g. Correspondingly, the pressure force as of which the at least one catcher structure 46 or 48 is overcome, may also be present only at a significant underpressure or overpressure. Consequently, for example, only after a longer centrifuging/pressure treatment of at least one test material is the relative motion of revolver component 12 able to be started again, with respect to reagent vessel part 10a or with respect to further revolver component 32.

Using the at least one semistable catcher structure 46 and 48, revolver component 12 is able to be held comparatively long in an intermediate position Sz1 and Sz2 with respect to reagent vessel part 10a or with respect to the further revolver component 32. This holding of revolver component 12 in the respective intermediate position Sz1 and Sz2 may be utilized to carry out chemical reactions and/or biochemical processes, which require longer times. Thereafter, revolver component 12 is able to be switched into another position, by way of increasing actuator force Fa above the threshold value established by the respective semistable catcher structure 46 and 48.

It should be pointed out once more that the advantages stated above also apply when a relative position of a stationary revolver component 12 is changed with respect to reagent vessel part 10a adjusted in the chamber or with respect to a further revolver component 32 adjusted in the chamber.

In the abovementioned reagent vessels 10/reagent vessel parts 10a/revolver components 12 still further process steps and structures may be integrated, such as sedimentation structures, channel structures or siphon structures for passing on and switching at least one liquid contained in reagent vessel 10/reagent vessel part 10a/revolver component 12. In particular, at least one subunit of the inner volume of a reagent vessel 10/reagent vessel part 10a/revolver component 12, as the “storage tank”, may be filled with at least one liquid which, using a subsequently filled in material/test material that is to be processed and/or tested, carries out at least one chemical reaction and/or a biochemical/molecular-biological process. The at least one “storage tank” may, for instance, be filled with chemicals, dyes, antibodies, antigens, receptors, proteins, DNA strands and/or RNA strands.

Reagent vessels 10/reagent vessel parts 10a/revolver components 12 may be made up at least partially of a polymer, for instance COP, COC, PC, PA, PU, PP, PET and/or PMMA. Additional materials are also suitable for forming reagent vessels 10/reagent vessel parts 10a/revolver components 12. These may be solid, elastic or flexible. Other suitable materials are, for instance, metal, polymers, paper, plastic, rubber material or the like. To subdivide reagent vessels 10/reagent vessel parts 10a/revolver components 12 into several (closed) liquid volumes, special chambers, containers and/or doors may be developed.

Reagent vessels 10/reagent vessel parts 10a/revolver components 12 may be equipped with still additional components, such as valves and/or pumps. In addition, the technology according to the present invention may cooperate in a simple manner with a plurality of conventional actuation units, detection units and/or control units.

Using reagent vessels 10/reagent vessel parts 10a/revolver components 12, chemical and biochemical processes may be carried out in a fully automated manner. It should be pointed out that the figures described may be interpreted as simplifications of implementable reagent vessels 10/reagent vessel parts 10a/revolver components 12.

1-15. (canceled)

16. A revolver component for a reagent vessel for at least one of a centrifuge and for a pressure-varying device, comprising:
a revolver housing configured to enable the revolver component to be installed in the reagent vessel;
a first one of a guide structure or an elevation provided on the revolver housing, wherein the first one of the guide structure or the elevation is configured to contact a second one of the guide structure or the elevation provided on one of a reagent vessel part or a further revolver component in such a way that the revolver housing is adjustable with respect to one of the reagent vessel part or the further revolver component, wherein an adjustment motion of the revolver housing with respect to one of the reagent vessel part or the further revolver component includes at least one first submotion aligned along an axis extending centrically through at least one of the revolver housing, the reagent vessel part, and the further revolver component;
wherein the guide structure is aligned so that the adjustable motion of the revolver housing with respect to one of the reagent vessel part or the further revolver component includes an additional second submotion directed about the axis.

17. The revolver component as recited in claim 16, wherein the guide structure is provided on the revolver component and is configured as one of a guide groove or a guide rail.

18. The revolver component as recited in claim 17, wherein the revolver component is set into the adjustment motion using at least one of (i) a centrifugal force during an operation of the centrifuge in which the reagent vessel is installed, and (ii) a pressure force during an operation of the pressure-varying device in which the reagent vessel is installed.

19. The revolver component as recited in claim 17, wherein the guide structure on the revolver component establishes an adjustment path of the revolver component set into the adjustment motion with respect to one of the reagent vessel part or the further revolver component, along which adjustment path the revolver component is adjusted from a first position into a second position with respect to one of the reagent vessel part or the further revolver component, and wherein the revolver component in the second position, in comparison to the revolver component in the first position, is adjusted into a first adjustment direction by a first non-zero path difference along the axis and by a first non-zero adjustment angle about the axis.

20. The revolver component as recited in claim 19, wherein:
the guide structure on the revolver component is configured in such a way that the revolver component is adjustable along the adjustment path from the second position to a third position with respect to one of the reagent vessel part or the further revolver component; and
the revolver component in the third position, in comparison to the revolver component in the second position, is adjusted into a second adjustment direction opposite to the first adjustment direction by a second non-zero path difference along the axis and by a second non-zero adjustment angle about the axis.

21. The revolver component as recited in claim 19, wherein the guide structure on the revolver component includes at least one part which is at least one of jag-shaped and arched.

22. The revolver component as recited in claim 21, wherein the guide structure on the revolver component extends at least one of meander-shaped and zigzag-shaped.

23. The revolver component as recited in claim 19, wherein the revolver component is configured as one piece with at least one of (i) spring projecting outwards on the revolver housing, (ii) an elastic support component, and (iii) a compressible support component.

24. The revolver component as recited in claim 19, wherein at least one semistable catcher structure is provided on the guide structure.

25. A reagent vessel part for a reagent vessel for at least one of a centrifuge and a pressure-varying device for cooperating with a revolver component, comprising:
one of a guide structure or an elevation provided on the reagent vessel part, wherein the other of the guide structure or the elevation is provided on the revolver component, and wherein the one of the guide structure or the elevation is configured in such a way that the revolver component is able to be adjusted with respect to the reagent vessel part, and wherein an adjustment motion of the revolver component with respect to the reagent vessel part includes at least one first submotion aligned along an axis extending centrically through at least one of the revolver housing of the revolver component and the reagent vessel part;
wherein at least one of the guide structure and the reagent vessel part is aligned in such a way that the revolver component set into the adjustment motion with respect to the reagent vessel part is adjusted into an additional second submotion directed about the axis.

26. The reagent vessel part as recited in claim 25, wherein the reagent vessel part is a revolver drum.

27. The reagent vessel part as recited in claim 25, wherein the guide structure is provided on the reagent vessel part, and wherein the guide structure is one of a guide groove or a guide rail.

28. The reagent vessel part recited in claim 27, wherein the guide structure includes at least one part which is at least one of jag-shaped and arched.

29. The reagent vessel part recited in claim 27, wherein at least one semistable catcher structure is provided on the guide structure.
